(19) United States
(12) Patent Application Publication
(10) Pub. No.: US 2018/0089750 A1
(43) Pub. Date: Mar. 29, 2018

(54) Light Fixture Selection Using Augmented Reality

(71) Applicant: Edwin Padilla, Windsor (CA)

(72) Inventor: Edwin Padilla, Windsor (CA)

(21) Appl. No.: 15/330,484

(22) Filed: Sep. 27, 2016

(51) Int. Cl. G06Q 30/06; G06T 19/00

(52) U.S. Cl. CPC G06Q 30/0643; G06F 3/04842; G06T 19/006

(57) ABSTRACT

A fixture can include a housing, a member for positioning the housing on or proximate to a surface in a room, an augmented reality (AR) target coupled to the housing and having a unique identifier for detection by an AR software application, and a light source disposed at least partially within the housing and configured to (i) illuminate the AR target for easier detection and (ii) at least partially illuminate the room. A method can include positioning the self-illuminated AR target in a possible position for an interior decoration in the room, initiating the AR software application on a mobile computing device, capturing image data including the self-illuminated AR target with the mobile computing device, and viewing an AR view of the room on a display of the mobile computing device, the AR view including an AR view of the interior decoration at the possible position.

### CROSS-REFERENCE TO RELATED APPLICATIONS

This application claims the benefit of U.S. Provisional Application No. 61/855,730, filed on May 23, 2013, U.S. Provisional Application No. 61/959,713, filed on Sep. 3, 2013, and U.S. Provisional Application No. 61/964,226, filed on Dec. 30, 2013. The disclosures of the above applications are incorporated herein by reference in their entirety.

### FIELD

The present disclosure relates to visualizing interior decorations and, more particularly, light fixture selection using augmented reality.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

There is a particular use of this invention that deserves special mention in its application to new home, apartment, condominium, and office construction or renovated home, apartment, condominium, and office construction. This use of the invention relates to the installation of temporary light fixtures, equipped with targets by the builder or contractor involved in the building or renovation, These temporary light fixtures are of low cost and will be replaced by the purchaser of the home, apartment, condominium or office at some time after the purchase. Particularly with the purchase of a new home or condominium, the purchaser is provided with a light fixture allowance by the builder or contractor. Current practice is to require the purchaser to select their light fixtures prior to their moving into the new home or condominium. This forces hasty decisions in light fixture selection that may not be in the best interest of the purchaser. By allowing the purchaser to move into their new home or condominium using the fully functional temporary light fixtures, they can take their time selecting their desired final light fixtures by using augmented reality to locate various possible light fixtures into the room anchored by the temporary light fixture.

Referring now to FIG. 1, conventional visualization of interior decorations in a room 100 by a user 104 is illustrated. In this particular example, the user 104 is attempting to visualize possible light fixtures for the room 100 at various different locations. One possible light fixture 108 may be positioned on a wall 112 of the room 100. Another possible light fixture 116 may be positioned on a ceiling 120 of the room 100. Another possible light fixture 124 may be positioned on a floor 128 of the room 100 or on a top surface 132 of a piece of furniture 136 (e.g., a table) that is above the floor 128. It may be difficult for the user 104 to visualize how these various possible light fixtures will look within the room 100 and/or how they will illuminate the room 100.

### SUMMARY

A fixture is presented. The fixture can include a housing, a member for positioning the housing on or proximate to a surface in a room, an augmented reality (AR) target coupled to the housing and having a unique identifier for detection by an AR software application, and a light source disposed at least partially within the housing and configured to (i) illuminate the AR target for easier detection by the AR software application and (ii) at least partially illuminate the room.

In some embodiments, the light source is powered by a battery. In other embodiments, the light source is powered via a power outlet in the room. In some embodiments, the light source is an edge-lighting source about an inside edge of the housing.

In some embodiments, the unique identifier is a unique pattern or a unique two-dimensional barcode. In other embodiments, the unique identifier corresponds to a set of possible light fixtures for the AR software application. In some embodiments, the AR target is permanently coupled to the housing.

In some embodiments, the housing is configured to be decoupled from the AR target and coupled with another AR target having another unique identifier for detection by the AR software application and corresponding to another set of possible light fixtures for the AR software application.

In other embodiments, the member includes at least one of a screw, an adhesive, and a back surface of the housing opposite the AR target. In some embodiments, the member is a free-standing structure configured to position the housing proximate to the surface.

A method for visualizing interior decorations in a room by a user is also presented. The method can include positioning a self-illuminated AR target in a desired position in the room, the desired position being a possible position for an interior decoration in the room, the self-illuminated AR target having a unique identifier for detection by an AR software application. The method can include initiating the AR software application on a mobile computing device. The method can include positioning the mobile computing device to capture image data of the room including the self-illuminated AR target. The method can also include viewing an AR view of the room on a display of the mobile computing device, the AR view of the room including an AR view of the interior decoration at the desired position.

In some embodiments, the method further includes: moving to a different location in the room while positioning the mobile computing device to continue capturing image data of the room including the self-illuminated AR target, and viewing the AR view of the room including the AR view of the interior decoration at the desired position on the display of the mobile computing device.

In other embodiments, the method further includes comprising controlling the mobile computing device to purchase the interior decoration. In some embodiments, the interior decoration is one of a light fixture, a piece of furniture, a wall decor, and a plant.

In other embodiments, the self-illuminated AR target is a fixture comprising: a housing, a member for positioning the housing on or proximate to the desired position, an AR target coupled to the housing and having the unique identifier for detection by the AR software application, and a light source disposed at least partially within the housing, configured to illuminate the AR target for easier detection by the AR software application, and configured to at least partially illuminate the room.

In some embodiments, the unique identifier corresponds to a set of possible interior decorations for the AR software application. In other embodiments, the AR target is permanently coupled to the housing. In some embodiments, the method further includes decoupling the housing from the AR target and coupling another AR target to the housing, the other AR target having another unique identifier for detection by the AR software application and corresponding to another set of possible interior decorations for the AR software application

In other embodiments, the member includes at least one of a screw, an adhesive, and a back surface of the housing opposite the AR target. In some embodiments, the member is a free-standing structure configured to position the housing proximate to the desired position.

There is a particular embodiment that is used to allow the selection of light fixtures by new home buyers who have a lighting allowance from the home builder for the purchase of light fixtures. In this case the home builder or home renovator installs temporary light fixtures equipped with an augmented reality target that are going to be replaced by the final light fixtures selected by the home buyer at a later date. These temporary, augmented reality target equipped light fixtures are designed to be inexpensive and can be discarded after their replacement by the final light fixtures. The home buyer can use augmented reality to view potential final light fixtures in place, anchored by the augmented reality target in the room as filled with their furniture and wall decorations in place. The presence of the furniture and wall decorations in the augmented reality view with the AR image of the final light fixture, makes the decision as to which final light fixture to purchase simpler to make.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an illustration of a user visualizing interior decorations in a room according to the prior art;

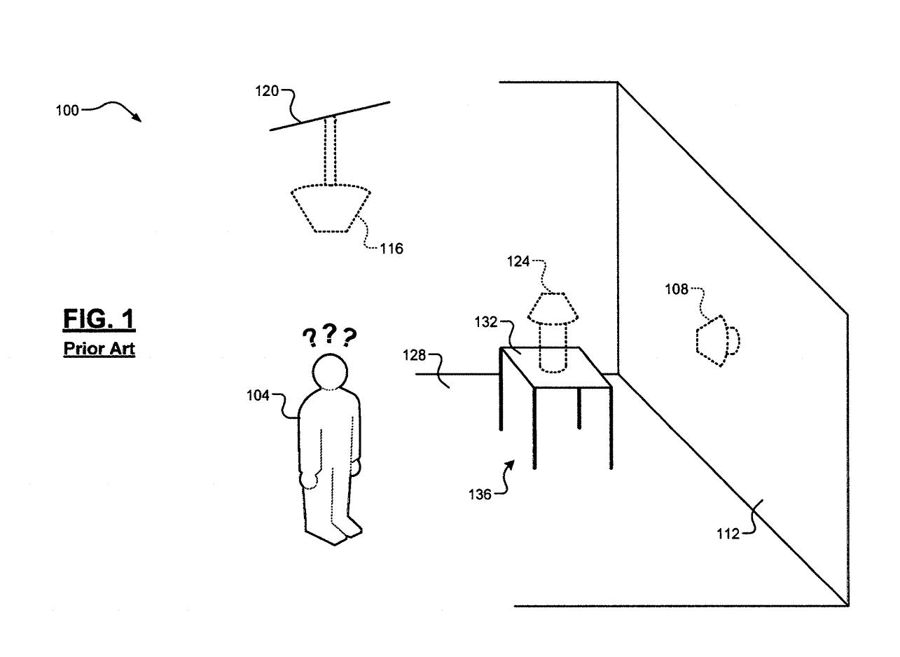

FIG. 2 is an illustration of the user visualizing interior decorations in the room of FIG. 1 via augmented reality (AR) using an example AR target and an example mobile computing device according to some implementations of the present disclosure; and

FIG. 3 is a functional block diagram of the example mobile computing device of FIG. 2;

FIG. 4 is a flow diagram of an example technique for visualizing interior decorations in a room via AR using a self-illuminated AR target and a mobile computing device according to some implementations of the present disclosure;

FIGS. 5A-5D illustrate example fixtures including AR targets according to some implementations of the present disclosure; and

FIGS. 6A-6B illustrate example AR views of a room including example AR views of possible light fixtures according to some implementations of the present disclosure.

FIG. 7 illustrates a room in a newly built house with the light fixture wiring junction box in place.

FIG. 8 illustrates the installation of a temporary AR target equipped light fixture in the room of FIG. 7.

FIG. 9 illustrates the use of the augmented reality app to view an AR image of a potential future light fixture over the temporary AR target equipped light fixture of FIG. 8.

FIG. 10 illustrates the installation of the final light fixture to replace the temporary light fixture of FIG. 8.

### DETAILED DESCRIPTION

As previously discussed, there remains a need for improvement in the art of visualizing interior decorations in a room and, more particularly, light fixture selection. Accordingly, a fixture and a method are presented that allow a user to visualize interior decorations, such as possible light fixtures, using augmented reality (AR). The fixture can be positioned on or proximate to a possible position for a possible light fixture, and the fixture can include an AR target for detection by an AR software application executing on a mobile computing device. The fixture can also include a light source, and thus the AR target is self-illuminated thereby improving detection by the AR software application while also providing a light source in the room. The method can include the user to position the self-illuminated AR target on or proximate to various possible positions in the room, and then use the mobile computing device having the AR software application executing thereon to see an AR view of various possible light fixtures from various angles and at various possible positions throughout the room.

As used herein, the term “light fixture” can refer to any suitable lighting device that can be mounted to a surface in a room or can be positioned free-standing in a room. Examples of the surface include a ceiling of the room, a wall of the room, a floor of the room, and a surface of a piece of furniture in the room. While the techniques of the present disclosure are described with respect to light fixtures, it should be appreciated that the techniques may also be applied to visualizing other possible interior decorating items (a piece of furniture, a wall decor, a plant, etc.) at various positions in the room. As used herein, the term AR target can refer to any object having a unique identifier that is identifiable by an AR software application executing on a mobile computing device. Examples of the unique identifier include a unique pattern and a unique barcode, such as a two-dimensional barcode.

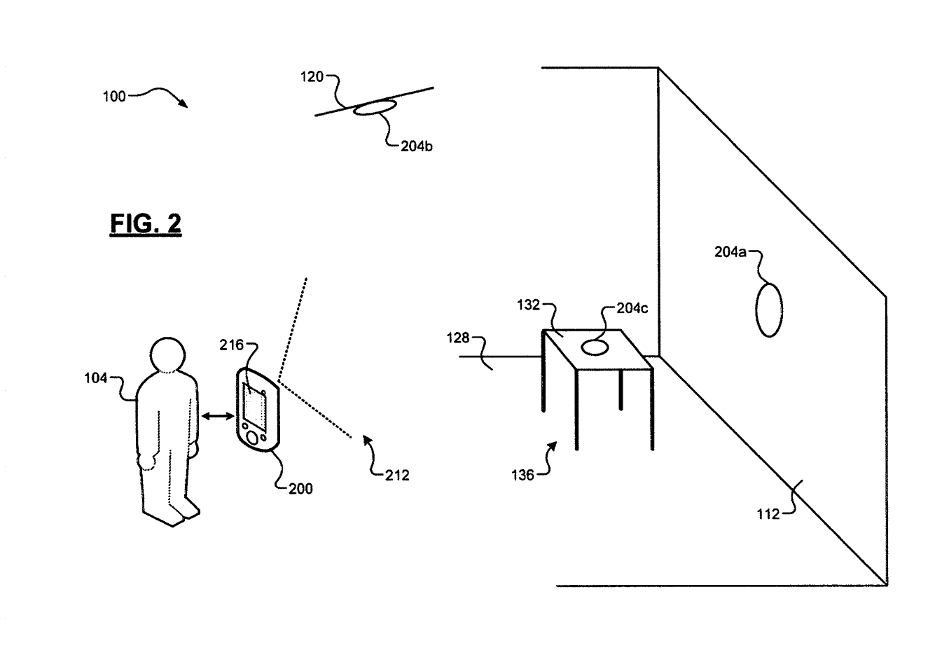

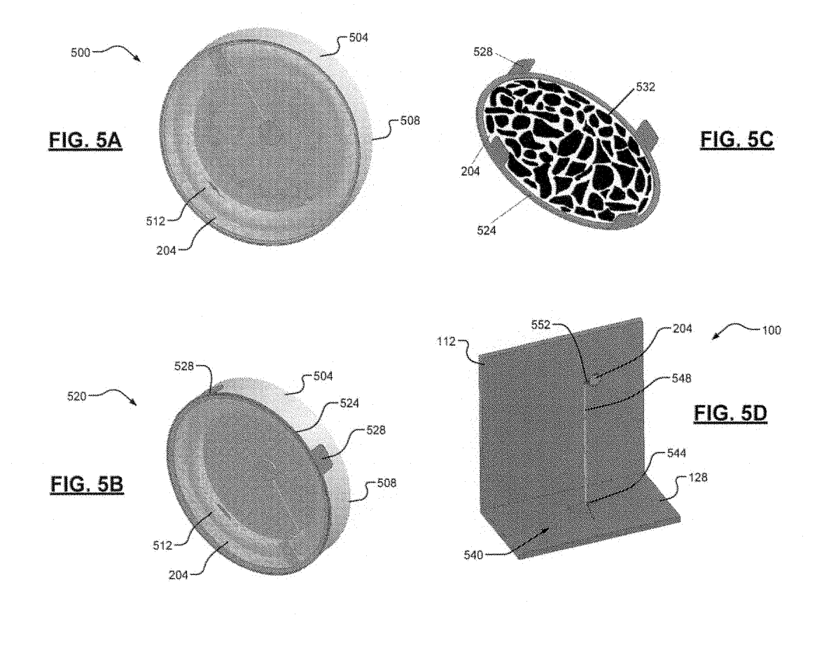

Referring now to FIG. 2, the user 104 can use a mobile computing device 200 to detect one or more of self-illuminated AR targets 204a, 204b, and 204c (collectively “self-illuminated AR targets 204”) positioned at various positions in the room 100. Each self-illuminated AR target 204 (hereinafter “AR target 204”) may be standalone or incorporated as part of a fixture (not shown), which is discussed in greater detail below with reference to FIGS. 5A-5D. In the illustrated example, the user 104 has positioned a first AR target 204a on the wall 112 of the room, a second AR target 204b on the ceiling 120 of the room 100, and a third AR target 204c on a surface 132 of the furniture 136 in the room 100 (or alternatively on the floor 128 of the room 100). Each of these AR targets 204 may have a different configuration such that the user 104 is able to position them on or proximate to these various positions with respect to these different surfaces.

After positioning each AR target 204, the user 104 can initiate an AR software application on the mobile computing device 200. The AR software application can be any suitable AR program that can identify unique identifiers from the AR target(s) 204. Examples of the mobile computing device 200 include a laptop computer, a tablet computer, a mobile phone, and wearable technology, such as eyewear incorporating a computing device. The mobile computing device 200 may alternatively be another computing device, such as a desktop computer. For example, a desktop computer may be used in conjunction with a moveable camera that can be positioned by the user 104. After initiating the AR software application, the user 104 can position the mobile computing device 200 to capture image data including a specific AR target 204. For example, this may include positioning the mobile computing device 200 such that its field of view or imaging region 212 captures image data including the AR target 204. The user 104 can then view an AR view of the room 100 on a display 216 of the mobile computing device 200. The AR view of the room 100 can include an AR view of a possible light fixture at the position of the AR target 204.

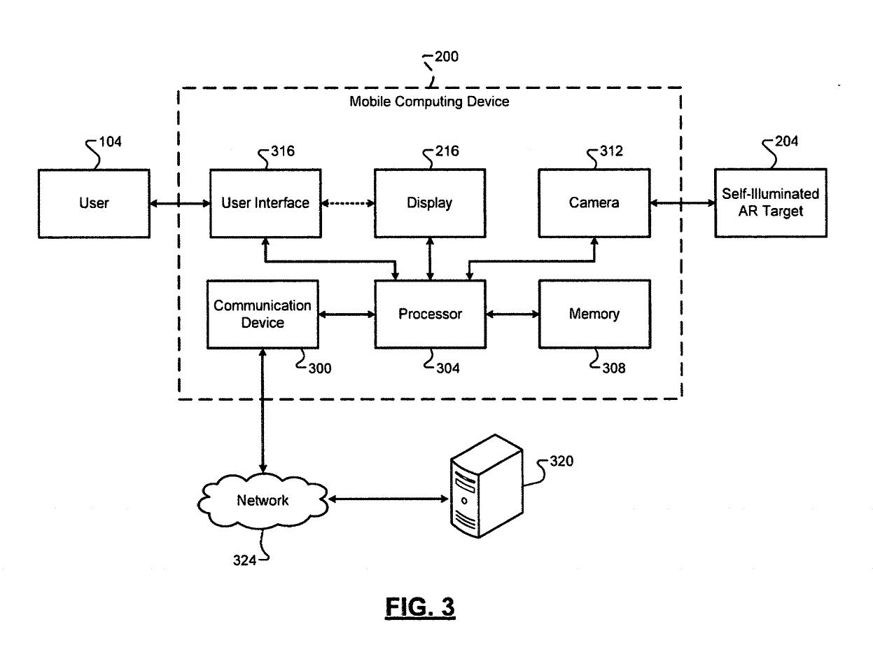

Referring now to FIG. 3, a functional block diagram of the example mobile computing device 200 is illustrated. The mobile computing device 200 can include the display 216, a communication device 300, a processor 304, a memory 308, a camera 312, and a user interface 316. The communication device 300 can include any suitable components (e.g., a transceiver) configured for communication with other components (e.g., a server 320) via a computing network 324. The processor 304 can control operation of the mobile computing device 200, including, but not limited to, executing the AR software application to capture image data and output AR views to the display 216. As used herein, the term “processor” can refer to both a single processor and a plurality of processors operating in a parallel or distributed architecture. The memory 308 can be any suitable storage medium (flash, hard disk, etc.) configured for permanent and/or temporary storage of information at the mobile computing device 200. The input device 316 can include any suitable components (keyboard, touchscreen, etc.) configured to receive user input, such as initiating the AR software application and/or selecting a possible light fixture for purchase after AR visualization.

Sets of possible light fixtures can be obtained and stored at the memory 308. For example, the sets of possible light fixtures may be obtained from the server 320 via the computing network 324. Purchases of possible light fixtures can also be performed via the computing network 324. For example, the user 104 may input a selection of a specific possible light fixture, which may automatically purchase that light fixture or redirect the user 104 to a webpage on the mobile computing device 200 where the user 104 can complete his/her purchase of that light fixture. In one implementation, different AR targets 204 can be associated with different sets of possible light fixtures. Thus, the user 104 may be able to switch AR targets and then utilize the mobile computing device 200 to view the AR view of the room 100 and a different light fixture from a different set of light fixtures. Alternatively, a single AR target 204 may be used, which can have a single unique identifier that can be detected by the AR software application executing on the mobile computing device 200. The user 104 may then select specific possible light fixtures via the mobile computing device 200, which can then be displayed in the AR views by the mobile computing device 200.

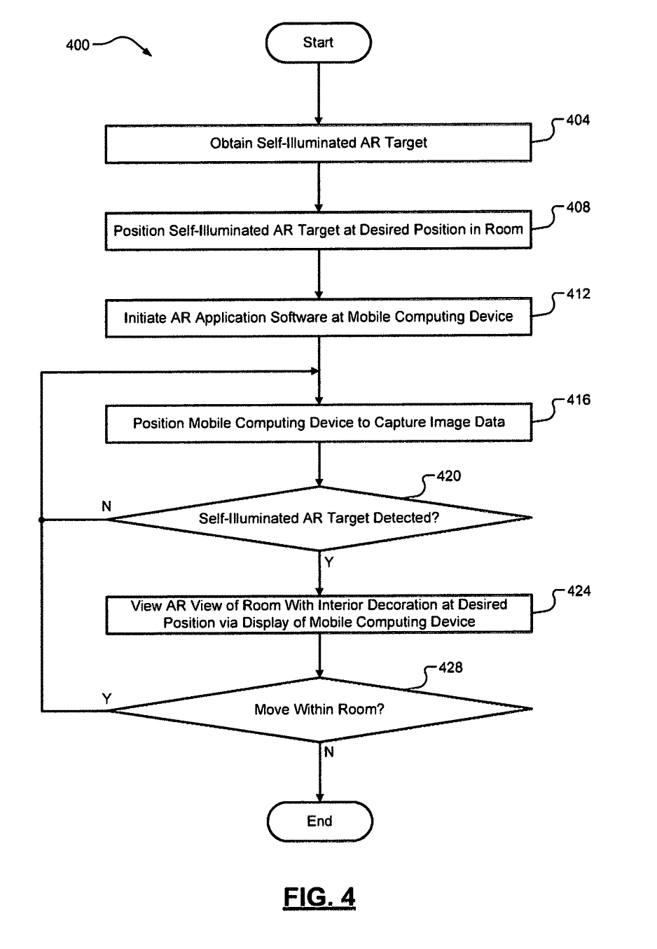

Referring now to FIG. 4, a flow diagram of an example technique 400 for interior decorations via AR using one or more of the AR targets 204 and the mobile computing device 200 is illustrated. At 404, the user 104 can obtain the AR target 404. At 408, the user 104 can position the AR target 408 at a desired position in the room 100. At 412, the user 104 can initiate an AR software application on the mobile computing device 200. At 416, the user 104 can position the mobile computing device 200 to capture image data, e.g., via the camera 312. At 420, the user 104 can determine whether the AR target 204 has been detected by the AR software application on the mobile computing device 200. For example, the AR software application may output an indication via the display 216 of the mobile computing device 200 indicating that the AR target 204 has been detected. If the AR target 204 has been detected, the technique 400 can proceed to 424. If the AR target 204 has not been detected, the technique 400 can return to 416.

At 424, the user 104 can view an AR view of the room 100 at the display 216 of the mobile computing device 200. The AR view of the room 100 can include an AR view of a possible light fixture at the desired position corresponding to the AR target 204. The possible light fixture may be selected or have been previously selected by the user 104 at the mobile computing device 200. At 428, the user 104 may decide whether to move within the room 100. For example, the user 104 may wish to view the AR view of the room 100 including the AR view of the possible light fixture from another angle. If the user 104 decides to move within the room 100, the technique 400 can return to 416. If the user 104 does not decide to move within the room 100, the technique 400 can end. For example, the user 104 may terminate the AR software application on the mobile computing device 200. The technique 400 may also return to 404 where the user 104 may position the AR target at a different possible location.

Referring now to FIGS. 5A-5D, example fixtures that include the AR target 204 are illustrated. FIG. 5A illustrates a first fixture 500 that includes a housing 504, a member 508 for positioning the housing 504, a light source 512, and the AR target 204 coupled to the housing 504. As illustrated, the housing 504 is a cylindrical or puck-like shape, but other suitable shapes and/or configurations of the housing 504 may be used. The light source 512 is at least partially disposed within the housing 504 and is configured to generate light to illuminate the AR target 504 and to at least partially illuminate a room.

As illustrated, the light source is tube light around an inner edge of the housing 504, but other suitable configurations of the light source 512 may be used, such as an incandescent bulb, one or more light emitting diodes (LEDs), or other tube light configurations. As illustrated, the member 508 is a back surface of the housing 504. The member 508 is operable to be positioned on a flat surface (a floor, a table, etc.) or mounted to a surface (a ceiling, a wall, etc.) using a fastener (screws, adhesive, etc.). As illustrated, the AR target 204 is permanently coupled to the housing 504.

FIG. 5B illustrates a second fixture 520 having a removable AR target 204. More specifically, the AR target 204 can include an edge 524 and one or more tabs 528 for coupling the AR target 204 to the housing 204. FIG. 5C illustrates the removable AR target 204 from FIG. 5B and further illustrates a unique identifier 532. As previously discussed, the unique identifier 532 can be a unique pattern as shown, or could similarly be another unique identifier such as a unique two-dimensional barcode. In some implementations, the AR target 204 can comprise a special edge-lit acrylic or plastic sheet that is capable of being illuminated. The unique identifier 532 can be printed directly onto this edge-lit sheet or printed onto another transparent material (e.g., a translucent vinyl sticker) and affixed to the edge-lit sheet.

FIG. 5D illustrates a third fixture 540 with respect to the room 100. As shown, the third fixture 540 includes a stand 544 for positioning on the floor 128, an extension device 548 for adjusting a height of the fixture with respect to the wall 112, and a retainer device 552 for retaining the AR target 204 in a desired position. In this example, the AR target 204 can further include the light source 512, and the fixture 540 is able to position the AR target 204 proximate to but not directly on a surface such as the wall 112. In addition, in this example the housing 504 can be the retainer device 552 and the member 508 can be the stand 544 and the extension device 548.

As previously mentioned herein, the AR target 204 can be either a standalone self-illuminating AR target or can be a different AR target that can be attached to a special light fixture for illumination. In some implementations, the standalone, self-illuminating AR target may only emit enough light to illuminate the AR target for AR detection purposes, but may not be able to light a portion of the room 100. The standalone, self-illuminating AR target, therefore, may be very lightweight and thus may be ideal for easy moving/placement by the user 104, particularly for locations having positioning issues due to gravity (attached to a wall, supported by the retainer device 552, etc.). This standalone, self-illuminated AR target can also be referred to as a “decor pad” because it resembles a pad that can be easily moved/positioned throughout the room for AR visualization of interior decorations by the user 104.

The special light fixture, however, can include a light source and can be hard-wired into an electrical system of the room 100 to obtain power for the light source. For example only, the light fixture could be hard wired into the ceiling 120 (e.g., during room construction) and used in the future in conjunction with the AR target for selection of a chandelier or other hanging light fixture, but otherwise still providing a light source for the room 100. This special light fixture, therefore, can also be referred to as a “temporary light fixture,” although the special light fixture could remain in the room 100 permanently if the user 104 desired.

In some implementations, this special light fixture can also include a quick connect/disconnect system. One example of the quick connect/disconnect system include a plug-in, sliding, serrated edge system. For example, a special outlet may be installed in a junction box in the ceiling 120 or the wall 112. This special outlet can allow various plug-in lighting fixtures to quickly connect/disconnect to/from the junction box, thus eliminating the need for an electrician to install a specific lighting fixture. By utilizing the AR visualization techniques of the present disclosure, this allows for a temporary lighting fixture (e.g., from a line of plug-in lighting fixtures) to be used to select and order a replacement lighting fixture (e.g., likely also in the same line of plug-in lighting fixtures).

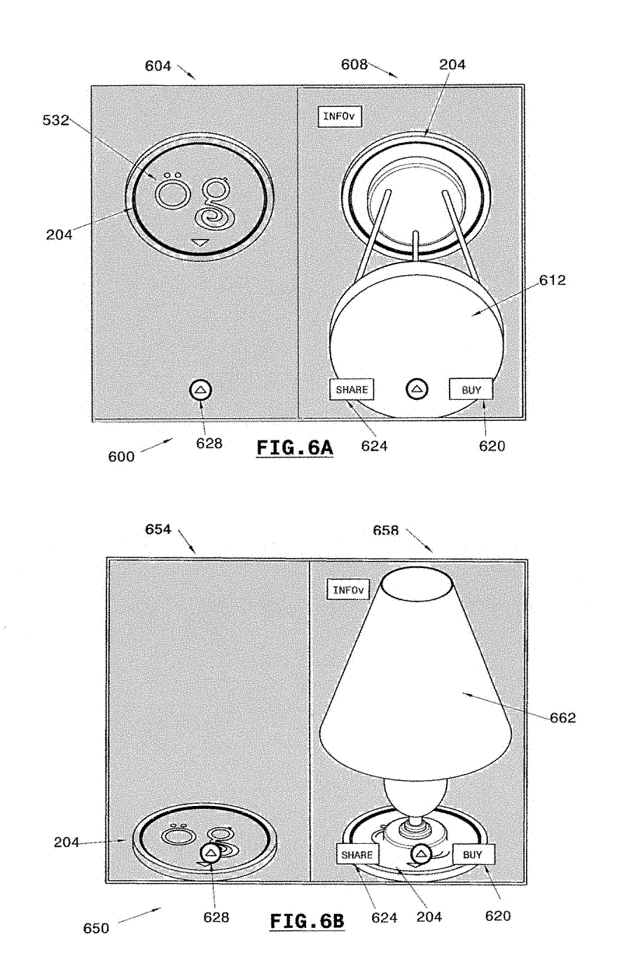

Referring now to FIGS. 6A-6B, example AR views of the room 100 including example AR views of possible light fixtures are illustrated. For example, these views may be presented via the display 216 of the mobile computing device 200. Each view, however, shows a side-by-side illustration of the AR target 204 not illuminated and illuminated. FIG. 6A illustrates a first view 600 having a non-illuminated AR view 604 and an illuminated AR view 608. As shown, the AR target 204 is barely visible in the non-illuminated view 604. In the illuminated AR view 608, however, the AR target 204 and the unique identifier 532 can be clearly seen, and the illuminated AR view 608 can further include an AR view 612 of a possible light fixture (in this case, a ceiling light or chandelier). Various icons can also be displayed via the display 216, such as a BUY icon 620 for executing purchases of the possible light fixture as discussed herein and/or a SHARE icon 624 for sharing the illuminated view 608 and/or product details for the possible light fixture via social media. In one implementation, another icon 628 may be used to indicate to the user 104 when the AR target 204 is detected. Similarly, FIG. 6B illustrates a second view 650 having a non-illuminated AR view 654 and an illuminated AR view 658. Again, the AR target 204 is barely visible in the non-illuminated AR view 654, but the AR target 204 can be clearly seen in the illuminated AR view 658. The illuminated AR view 658 can further include an AR view 662 of another possible light fixture (in this case, a table or floor lamp), which may be purchased and/or shared using the respective icons 620 and 624.

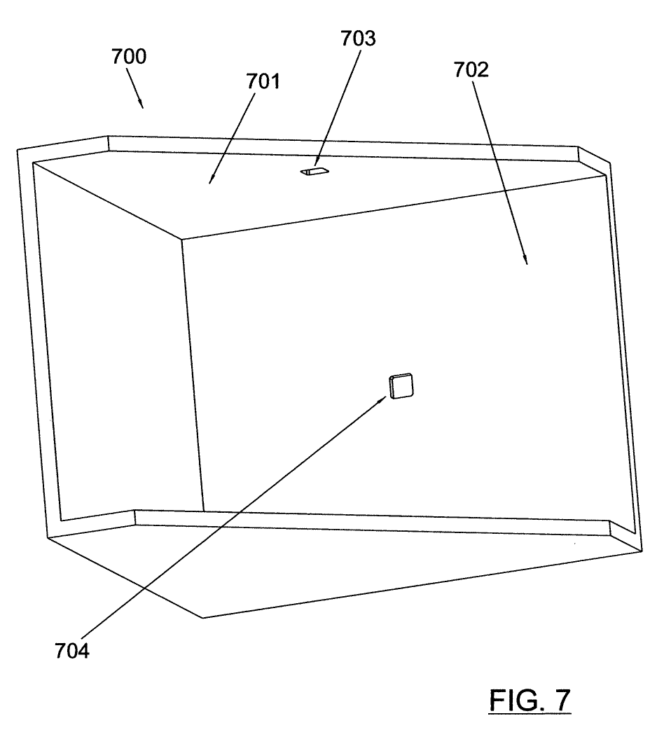

FIG. 7 shows a room 700 in a newly built or renovated house or condominium with the light fixture wiring junction box 703 installed in the ceiling 701 and the light fixture wiring junction box 704 installed in the wall 702. These light fixture wiring junction boxes 703 and 704 are located at spots where lighting fixtures will be installed.

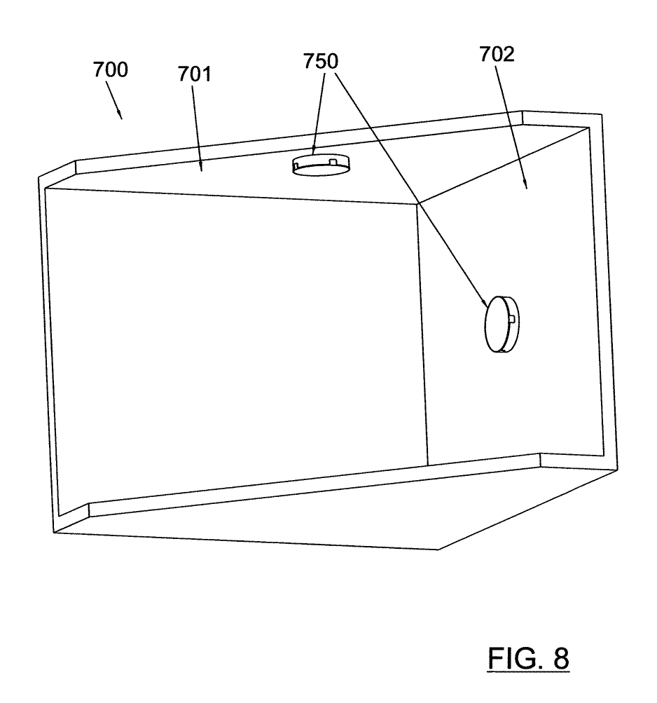

FIG. 8 shows a room 700 in a newly built house or condominium with a temporary AR target equipped light fixture 750 installed in the ceiling 701 and a temporary AR target equipped light fixture 750 installed in the wall 702. These temporary AR target equipped light fixture 750 are installed over the light fixture wiring junction boxes 703 and 704 shown in FIG. 7 and are therefore located at spots where new and final lighting fixtures will be installed in the future. These temporary AR target equipped light fixtures 750 are fully functional light fixtures capable of lighting the room and are designed to provide that function until they are replaced by new and final light fixtures selected through augmented reality.

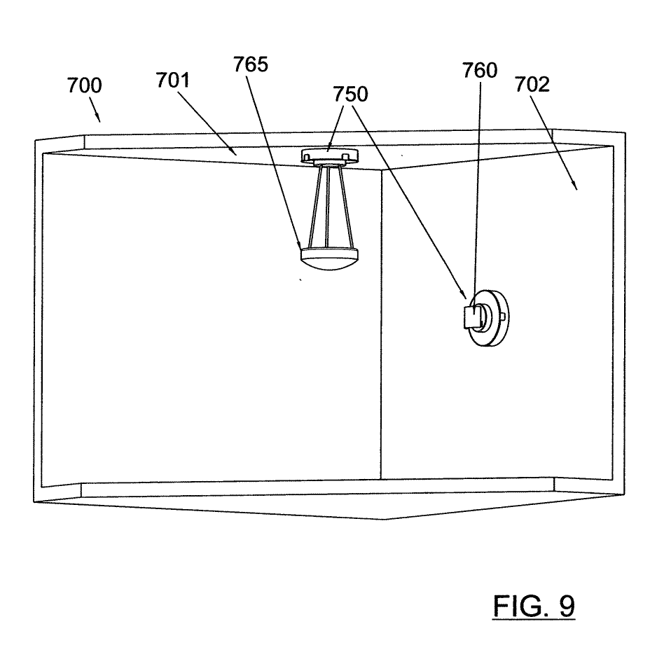

FIG. 9 shows a room 700 in a newly built or renovated house or condominium with a temporary AR target equipped light fixture 750 installed in the ceiling 701 and a temporary AR target equipped light fixture 750 installed in the wall 702. The augmented reality light fixture 765 is shown anchored to the temporary AR target equipped light fixture 750 mounted to the ceiling 701 while the augmented reality light fixture 760 is shown anchored to the temporary AR target equipped light fixture 750 mounted to the wall 702. These AR images 765 and 760 allow the user to select a particular light fixture from a large data base of AR light fixtures and then purchase that light fixture through an App.

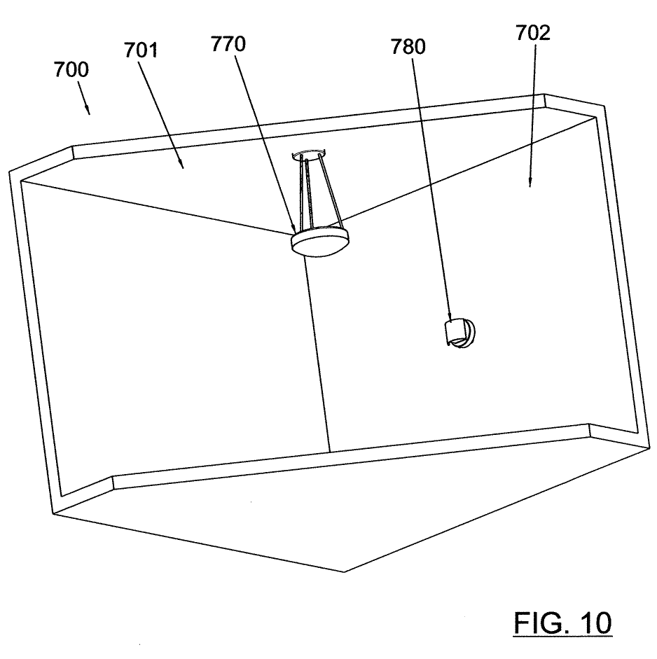

FIG. 10 shows a room 700 in a newly built or renovated house or condominium with the new and final light fixture 770 installed on the ceiling 701 connected to the light fixture wiring junction box 703 and the new and final light fixture 780 installed on the wall 702 connected to the light fixture wiring junction box 704. The light fixtures 770 and 780 are the same light fixtures that were selected using the AR images 765 and 760 as shown in FIG. 9.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of selecting a light fixture for a newly built or renovated room in a home or condominium comprising:
Installing a temporary AR equipped light fixture on the light fixture wiring junction box;
Using an augmented reality app in a mobile computing device to view various AR images of light fixtures anchored to the temporary AR equipped light fixture;
Selecting a particular final new light fixture and ordering it using the app on the mobile computing device;
Installing the new final light fixture in place of the temporary AR equipped light fixture.

2. The method of claim 1, wherein the temporary AR equipped light fixture is powered by a battery.

3. The method of claim 1, wherein the light source is powered by connection to the wiring in the light fixture wiring junction box.

4. The method of claim 1, wherein the temporary AR light fixture has an edge-lighting source about an inside edge of its housing.

5. The method of claim 1, wherein the temporary AR light fixture has an AR identifier is a unique pattern or a unique two-dimensional barcode.

6. The method of claim 5, wherein the unique identifier corresponds to a set of possible light fixtures for the AR software application.

7. The method of claim 1, wherein the AR target is removable from the temporary AR light fixture.

8. The method of claim 7, wherein the AR target is configured to be decoupled from the temporary AR light fixture and coupled with another temporary AR light fixture having another unique identifier for detection by the AR software application and corresponding to another set of possible light fixtures for the AR software application.

9. The method of claim 1, wherein the temporary AR light fixture includes at least one of a screw, an adhesive, and a back surface of the housing opposite the illuminated side of the temporary AR light fixture.

10. A method for visualizing light fixtures in a room of a newly built or renovated home or condominium by a user, the method comprising:
initiating the AR software application on a mobile computing device;
positioning the mobile computing device to capture image data of the room including a temporary AR light fixture; and
viewing an AR view of the room on a display of the mobile computing device, the AR view of the room including an AR view of the temporary AR light fixture at its position.

11. The method of claim 10, further comprising:
moving to a different location in the room while positioning the mobile computing device to continue capturing image data of the room including the temporary AR light fixture; and
viewing the AR view of the room including the AR view of the temporary AR light fixture at the desired position on the display of the mobile computing device.

12. The method of claim 12, further comprising controlling the mobile computing device to purchase the lighting fixture.
